(19) United States
(12) Patent Application Publication
(10) Pub. No.: US 2025/0144454 A1
(43) Pub. Date: May 8, 2025

(54) RESPIRATOR

(71) Applicant: 3M INNOVATIVE PROPERTIES COMPANY, St. Paul, MN (US)

(72) Inventors: Nathan E. Schultz, Woodbury, MN (US); Seth M. Kirk, Minneapolis, MN (US); David A. Olson, St. Paul, MN (US); Ronald W. Ausen, St. Paul, MN (US); John M. Brandner, St. Paul, MN (US); Bongyeol Yeom, Woodbury, MN (US)

(21) Appl. No.: 18/837,418

(22) PCT Filed: Feb. 3, 2023
(86) PCT No.: PCT/IB2023/050986

§ 371 Date: Aug. 9, 2024

Related U.S. Application Data
(60) Provisional application No. 63/268,108, filed on Feb. 16, 2022.

(51) Int. Cl. A62B 23/02; A62B 18/08

(52) U.S. Cl. CPC A62B 23/025; A62B 18/084

(57) ABSTRACT

A respirator is disclosed. The respirator includes a mask body and a harness. The mask body includes polypropylene in an amount of between 60 and 100 weight percent. The harness is attached to the mask body. The harness includes elastomeric polypropylene-miscible copolymer in an amount of between 80 and 100 weight percent. The respirator includes an overall composition of polypropylene of at least 80 weight percent. The respirator includes an overall composition of ethylene of less than 10 weight percent. The respirator may be consistent with definition of recyclable according to Association of Plastic Recyclers (APR) standards for polypropylene.

### TECHNICAL FIELD

The present disclosure relates generally to respirators.

### BACKGROUND

Respirators are widely used for respiratory protection. Conventional respirators may include various components (e.g., cover webs, filters, nose foam, etc.) that are made from different materials, such as polypropylene, aluminum, polyester, isoprene, polyurethane, and so forth. As a result, the conventional respirators may not be recyclable in a single recycling stream such as, for example, a polypropylene recycling stream.

### SUMMARY

Therefore, there is a need for a respirator that can be recycled as opposed to being disposed of in a landfill.

In a first aspect, the present disclosure provides a respirator comprising: a mask body comprising polypropylene in an amount of between 60 and 100 weight percent; and a harness attached to the mask body, the harness comprising elastomeric polypropylene-miscible copolymer in an amount of between 80 and 100 weight percent; wherein the respirator comprises an overall composition of polypropylene of at least 80 weight percent, and wherein the respirator comprises an overall composition of ethylene of less than 10 weight percent.

In a second aspect, the present disclosure provides a method of recycling the respirator of the first aspect, the method comprising recycling the respirator in a polypropylene recycling stream.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

Exemplary embodiments disclosed herein may be more completely understood in consideration of the following detailed description in connection with the following figures. The figures are not necessarily drawn to scale. Like numbers used in the figures refer to like components. However, it will be understood that the use of a number to refer to a component in a given figure is not intended to limit the component in another figure labeled with the same number.

FIG. 1A is a schematic perspective view of a respirator according to an embodiment of the present disclosure worn by a user;

FIG. 1B is a schematic view of a face contact side of the respirator of FIG. 1A;

FIG. 1C is a schematic view of a face contact side of a respirator according to another embodiment of the present disclosure;

FIG. 2 is a schematic cross-sectional view of a portion of a respirator according to another embodiment of the present disclosure;

FIG. 3 is a schematic cross-sectional view of a portion of a respirator according to another embodiment of the present disclosure;

FIG. 4 is a cross-sectional view of a portion of a respirator according to another embodiment of the present disclosure;

FIG. 5 is a perspective view of a support structure of the respirator according to an embodiment of the present disclosure; and

FIG. 6 is a flowchart depicting various steps of a method of recycling a respirator according to an embodiment of the present disclosure.

### DETAILED DESCRIPTION

In the following description, reference is made to the accompanying figures that form a part thereof and in which various embodiments are shown by way of illustration. It is to be understood that other embodiments are contemplated and may be made without departing from the scope or spirit of the present disclosure. The following detailed description, therefore, is not to be taken in a limiting sense.

In the following disclosure, the following definitions are adopted.

As recited herein, all numbers should be considered modified by the term “about”. As used herein, “a,” “an,” “the,” “at least one,” and “one or more” are used interchangeably.

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties).

The term “substantially”, unless otherwise specifically defined, means to a high degree of approximation (e.g., within +/−10% for quantifiable properties) but again without requiring absolute precision or a perfect match.

The term “about”, unless otherwise specifically defined, means to a high degree of approximation (e.g., within +/−5% for quantifiable properties) but again without requiring absolute precision or a perfect match.

Terms such as same, equal, uniform, constant, strictly, and the like, are understood to be within the usual tolerances or measuring error applicable to the particular circumstance rather than requiring absolute precision or a perfect match.

As used herein, the terms “first” and “second” are used as identifiers. Therefore, such terms should not be construed as limiting of this disclosure. The terms “first” and “second” when used in conjunction with a feature or an element can be interchanged throughout the embodiments of this disclosure.

As used herein, when a first material is termed as “similar” to a second material, at least 90 weight % of the first and second materials are identical and any variation between the first and second materials comprises less than 10 weight % of each of the first and second materials.

As used herein, “at least one of A and B” should be understood to mean “only A, only B, or both A and B”.

As used herein, the term “respirator” refers to an article capable of removing contaminants from ambient atmospheric air space when a user wearing the respirator inhales.

As used herein, the term “mask body” refers to a structure that fits over a nose and a mouth of the user. The mask body of a respirator may include one or more structures that remove contaminants from air that passes therethrough, provide comfort to the user, etc. As used herein, the term “harness” refers to a structure or a combination of parts that assists in supporting the mask body on a face of the user. For example, a harness may include earloops to support the mask body on the face of the user.

As used herein, the term “filtering structure” refers to an air-permeable structure capable of removing contaminants (such as particles) from an air stream passing therethrough. The filtering structure may be configured to achieve a filtration standard, for example, N95 filtration, N99 filtration, P100 filtration, OV-100 filtration, and so forth.

As used herein, the term “support structure” refers to a structure that supports other structures of the mask body. The support structure may provide a definite shape to the mask body. The support structure may be collapse resistant and have a three dimensional shape. In other words, the support structure may be capable of retaining its shape under normal use. The support structure may be foldable. In other words, the support structure may be capable of folding, for example, to a flat structure.

As used herein, the term “cover web” refers to a structure that is not primarily designed for filtering contaminants. Cover webs may be nonwoven and fibrous. Cover webs may be smooth and have a high degree of softness to provide increased comfort to the user when wearing the respirator. The cover web may also provide abrasion resistance. As a result, the cover web may reduce or prevent undesired abrasion.

As used herein, the term “nose foam” refers to a compressible porous material that is adapted for placement on the mask body to improve a fit and/or comfort over the nose of the user.

As used herein, the term “full perimeter seal” refers to a compressible porous material that is adapted for placement on the mask body to improve a fit and/or comfort over the face of the user.

As used herein, the term “polypropylene” refers to propylene homopolymers, i.e., polypropylene, or those polyolefins composed primarily of propylene and may contain comonomers. Examples of comonomers include ethylene, 1-octene, 1-hexene, or other monomers. One example of suitable comonomer includes ethylene based resins under the trade name DOWLEX™ from The Dow Chemical Company.

As used herein, the term “ethylene” refers to C₁-C₁₂ alkenes. Ethylene may act as a monomer that polymerizes to form polyethylene. The term “composition of ethylene” refers to an amount of ethylene or polymers composed primarily of ethylene present in a structure. For example, a structure including an overall composition of ethylene of 25 weight percent, means that 25% of the weight of the structure is of ethylene.

As used herein, the term “polypropylene-miscible copolymer” refers to blends of copolymers that are at least partially miscible with polypropylene. Polypropylene-miscible copolymers may include, for example, a blend including polypropylene in an amount of 60 or more weight percent and ethylene in an amount of 40 or less weight percent. An example of polypropylene-miscible copolymer includes polypropylene in an amount of 85 weight percent and ethylene in an amount of 15 weight percent.

As used herein, the term “elastomeric” refers to an elastic property. The term “elastomeric” when used in conjunction with a material, compound, or element signifies that the material, compound, or element possesses the elastic property. For example, an elastomeric material may substantially recover its original dimensions after compression and/or elongation. An elastomeric material, upon application of a force to its relaxed, initial length may stretch or elongate to an elongated length more than 10% greater than its initial length and may substantially recover back to its initial length upon release of the applied force.

As used herein, the term “slip agent” refers to any substance, whether in solid or liquid form, that when mixed with a material reduces a coefficient of friction of the material along its surface as compared to the material without the substance.

As used herein, the term “matte finish” refers to the result of any process or combination of materials that reduces the coefficient of friction of the material along its surface as compared to the material with a smooth surface. This may enable the use of a material without a slip agent.

As used herein, the term “uncrosslinked polymer” refers to a polymer that is not crosslinked, i.e., an uncrosslinked polymer is not subjected to active crosslinking through the addition of a crosslinker to the polymer. Crosslinking may also occur through a process such as UV-radiation or e-beaming exposure.

As used herein, the term “ultrasonic welding” refers to a technique in which high-frequency ultrasonic acoustic vibrations are used to weld elements together. The term “ultrasonically weldable” refers to a property of elements to be welded to each other via ultrasonic welding.

As used herein, the term “printed indicia” refers to a marking, image, text, and/or symbol located on the surface of a film, sheet, or web. The printed indicia can be disposed on the surface by any suitable means (e.g., ink printing, laser printing, etc.). The printed indicia can include, e.g., a printed message or instructions, list of ingredients (active and inactive), weight of product, manufacturer name and address, manufacturer trademark, etc.

As used herein, the term “between” as used in ranges is inclusive of the endpoints. For example, a composition ranging between 20 and 30 includes both 20 and 30.

A respirator is an article of personal protective equipment (PPE) commonly worn by a user who works in areas where air may be contaminated with toxic substances, such as airborne particulates, gases, and vapors, that are harmful to the user. The respirator may filter out toxic chemicals, gases, and/or airborne particles from air breathed by the user. Some examples of the respirator include N95 masks, N96 masks, N97 masks, N98 masks, N99 masks, and the like.

Conventional respirators may include various components, such as a filter, a shell, a nose bar, a headband, a nose foam, and the like. The components of the conventional respirators may be made from different materials such as polypropylene, aluminum, polyester, isoprene, polyurethane, and any other suitable materials. As a result, the conventional respirators may not be recyclable in a single recycling stream.

The present disclosure relates to a respirator. The respirator includes a mask body including polypropylene in an amount of between 60 and 100 weight percent. The respirator further includes a harness attached to the mask body. The harness includes elastomeric polypropylene-miscible copolymer in an amount of between 80 and 100 weight percent. The respirator includes an overall composition of polypropylene of at least 80 weight percent. The respirator further includes an overall composition of ethylene of less than 10 weight percent.

The respirator of the present disclosure may be recyclable in a single recycling stream. Specifically, the respirator may be recyclable in a polypropylene recycling stream, as the respirator includes polypropylene in an amount of at least 80 weight percent. Further, the respirator of the present disclosure may follow the guidelines provided by Association of Plastic Recyclers (APR) to be recyclable in the polypropylene recycling stream. Therefore, the respirator may be recyclable according to APR standards for polypropylene.

The harness of the respirator of the present disclosure may include elastomeric polypropylene-miscible copolymer instead of isoprene. Isoprene is conventionally used to form the harness and may act as a contaminant in the polypropylene recycling stream. Further, isoprene is crosslinked, which may further cause problems during recycling. Moreover, the harness of the present disclosure may be ultrasonically welded to the mask body of the respirator. This may reduce a time taken to manufacture the respirator, improve a quality of bond between the mask body and the harness, and reduce production costs. Moreover, the respirator of the present disclosure may allow use of uncrosslinked polymers instead of urethane polymer and crosslinked polymers. Crosslinked polymers may be unacceptable in the polypropylene recycling stream.

In some examples, the respirator of the present disclosure may include a collapse resistant shell that has a three-dimensional shape. The collapse resistant shell may include a protuberant or shaped nose portion so as to eliminate requirement of metal nose bars, which are typically used in flat-fold type respirators. In some cases, the collapse resistant shell may include a blend of polypropylene-miscible copolymers in order to prevent embrittlement.

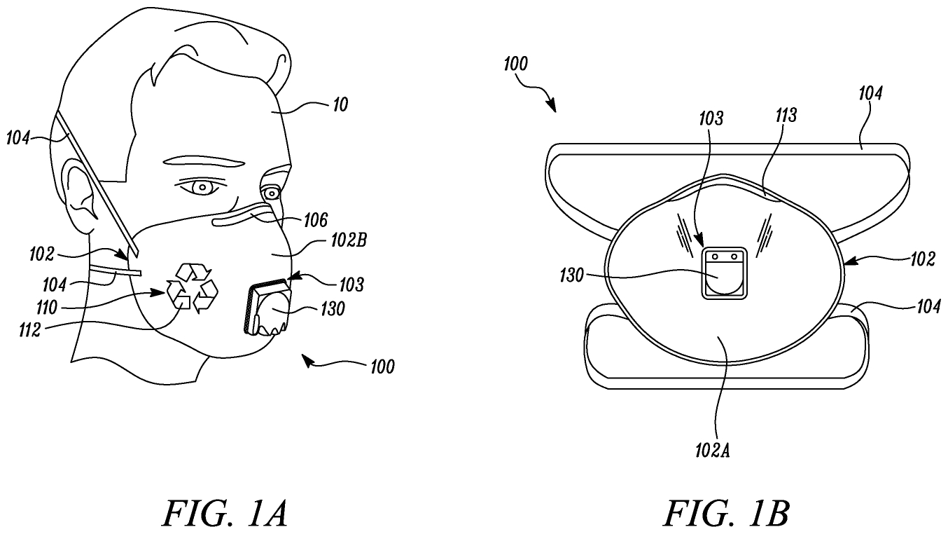

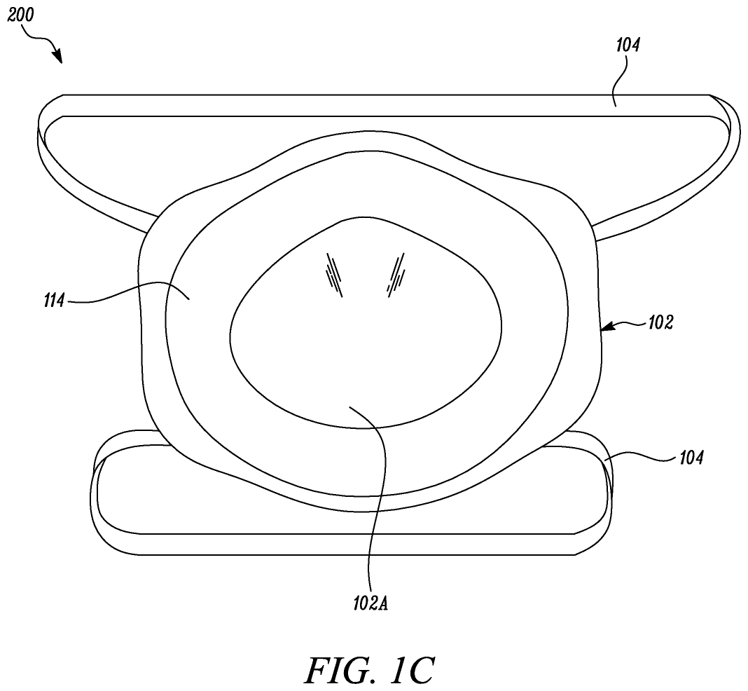

Referring now to figures, FIGS. 1A and 1B illustrate a respirator 100 according to an embodiment of the present disclosure. Specifically, FIG. 1A illustrates a schematic perspective view of the respirator 100 worn by a user 10, and FIG. 1B illustrates a schematic view of a face contact side of the respirator 100.

The respirator 100 includes a mask body 102. The mask body 102 may fit over a nose and a mouth of the user 10. The mask body 102 includes polypropylene in an amount of between 60 and 100 weight percent. In some embodiments, the mask body 102 may include polypropylene in an amount of 65, 70, 75, 80, 85, 90, or 95 weight percent.

In some embodiments, the mask body 102 further includes polypropylene-miscible copolymer in an amount of between 0 and 40 weight percent. In some embodiments, the mask body 102 may include polypropylene-miscible copolymer in an amount of 5, 10, 15, 20, 25, 30, or 35 weight percent.

The respirator 100 further includes a harness 104 attached to the mask body 102. The harness 104 may support the mask body 102 on the face of the user 10. In the illustrated embodiment of FIGS. 1A and 1B, the harness 104 includes a pair of headbands. However, the harness 104 may include any device or combination of elements for supporting the mask body 102 on the face of the user 10. For example, the harness 104 may include a pair of earloops to support the mask body 102 on the face of the user 10. In some embodiments, the harness 104 includes a head suspension system. The head suspension system may include a plurality of headbands in any suitable configuration for supporting the mask body 102 on the face of the user 10.

The harness 104 includes elastomeric polypropylene-miscible copolymer in an amount of between 80 and 100 weight percent. In some embodiments, the harness 104 may include elastomeric polypropylene-miscible copolymer in an amount of 85, 90, or 95 weight percent.

In some embodiments, the harness 104 further includes ethylene in an amount of at least 10 weight percent. In other words, in some embodiments, the harness 104 includes elastomeric polypropylene-miscible copolymer with at least 10% ethylene content. In some embodiments, the harness 104 may include ethylene in an amount of at least 11, at least 12, at least 14, at least 16, at least 18, or at least 20 weight percent. The ethylene content in the harness 104 may improve mechanical properties of the harness 104, such as elongation at break, tensile load, and the like. Moreover, the ethylene content may improve an elastomeric property of the harness 104.

The harness 104 may require low self-adhesion in order to properly support the mask body 102 on the face of the user 10 and to not stick to itself during use of the respirator 100.

Therefore, in some embodiments, the harness 104 further includes a slip agent in an amount of less than 7 weight percent. In one example, the harness 104 having a thickness of 0.4 millimeters may include 700 parts per million (ppm) of the slip agent. The slip agent may reduce self-adhesion of the harness 104. However, in some other embodiments, the harness 104 may be made with a matte finish on its surfaces. In such embodiments, the harness 104 may be made without the slip agent.

In some embodiments, the slip agent includes a fatty acid amide. In some embodiments, the slip agent includes at least one of erucamide, ethylene bis stearamide (EBS), silica gel, behenamide, and stearamide, or a combination thereof.

The harness 104 may include a combination of different slip agents to provide an improved surface finish. Specifically, in some embodiments, the harness 104 includes primary fatty acid in an amount of 2.5 weight percent and silica gel in an amount of 2.5 weight percent.

Further, in some embodiments, each of the mask body 102 and the harness 104 is ultrasonically weldable. The mask body 102 and the harness 104 may be ultrasonically weldable due to their compositions as disclosed herein. In some embodiments, the harness 104 is attached to the mask body 102 via ultrasonic welding.

The respirator 100 includes an overall composition of polypropylene of at least 80 weight percent. In some embodiments, the respirator 100 may include an overall composition of polypropylene of 85, 90, or 95 weight percent. Further, the respirator 100 includes an overall composition of ethylene of less than 10 weight percent. In some embodiments, the respirator 100 may include an overall composition of ethylene of less than 9, less than 8, less than 7, less than 6, or less than 5 weight percent. As a result, the respirator 100 is consistent with definition of recyclable according to Association of Plastic Recyclers (APR) standards for polypropylene. Specifically, the respirator 100 is consistent with the definition of recyclable according to APR standards: PP-CG-01. Some aspects of the APR standards for polypropylene are provided in the table below.

APR STANDARDS

| Recycling | | |
|---|---|---|
| Aspect | Criteria | Note |
| Material | Polypropylene-based | 1. Density <1.0 g/cc |
| | | 2. Primary melting peak <180° C. |
| | | (measured by DSC) |
| | | 3. <10% PE |
| | | 4. Extrudable w/o pressure build |
| Sorting | Identifiable as PP with | 1. Cannot be black. |
| | infrared | |
| Sorting | More three | 1. Greater than 2.5 inches in all |
| | dimensional than two | dimensions |
| | dimensional | 2. Not paper- or box-like |
| Sorting | Metal free | |

The mask body 102 includes a first major surface 102A and a second major surface 102B opposite to the first major surface 102A. The first major surface 102A and the second major surface 102B are used interchangeably in the present disclosure.

In the illustrated embodiment of FIGS. 1A and 1B, the first major surface 102A faces the user 10, and the second major surface 102B faces an external environment. However, in some other embodiments, the first major surface 102A may face the external environment and the second major surface 102B may face the user 10.

Further, in the illustrated embodiment of FIGS. 1A and 1B, the respirator 100 is a flat-fold respirator. In other words, in the illustrated embodiment of FIGS. 1A and 1B, the respirator 100 may include a plurality of portions that can fold flat and can unfold into an open, in-use configuration. Further, in such embodiments, layers of the respirator 100 that are foldable may be collapse resistant and thus may not become embrittled during use of the respirator 100. However, in some other embodiments, the respirator 100 may not be a flat-fold respirator and may have a collapse resistant three-dimensional shape, such as a cup shape.

In the illustrated embodiment of FIG. 1A, the respirator 100 further includes a nose bar 106 removably attached to a surface (the second major surface 102B in FIG. 1A) of the mask body 102. The nose bar 106 may be removed from the mask body 102 when desired. The nose bar 106 may allow custom fitting of the respirator 100 around the nose of the user 10.

In some embodiments, the nose bar 106 is made of a metal or a metal alloy. For example, the nose bar 106 may be made of aluminum, aluminum-zinc alloy, galvanized fine iron, galvanized steel, and any other metal or metal alloy as per design feasibility and requirement. In some other embodiments, the nose bar 106 is made of a non-metallic material. For example, the nose bar 106 may be made of plastics, such as polyolefins (e.g., polyethylene and polypropylene), or any other non-metallic material as per design feasibility and requirement. In some embodiments, the nose bar 106 is made of a metal, a metal alloy, a plastic, or a non-metallic material.

However, it may be noted that the nose bar 106 is optional and may be omitted from the respirator 100 (e.g., in embodiments where the respirator 100 is not a flat-fold respirator and has a collapse resistant three dimensional shape).

In some embodiments, the respirator 100 further includes printed or embossed indicia 110 disposed on a surface (the second major surface 102B in FIG. 1A) of the mask body 102. The printed indicia 110 may include any suitable combination of alphanumeric characters, symbols, visual or pictorial elements, colors, and the like. The printed indicia 110 may be formed by any suitable printing process, such as offset printing, flexography, rotogravure, digital printing process, and the like.

In some embodiments, the printed indicia 110 include an American Society for Testing and Materials (ASTM) resin classification code. The ASTM resin classification code may represent a composition of the respirator 100. In some cases, the ASTM resin classification code may represent that the respirator 100 is primarily made of polypropylene.

In the illustrated embodiment of FIG. 1A, the printed indicia 110 includes one or more labels 112. In some embodiments, the one or more labels 112 describe a material of the respirator 100 to facilitate recycling thereof. Further, in some embodiments, the one or more labels 112 describe recycling instructions. That is, in some embodiments, the one or more labels 112 may provide instructions describing a process of recycling the respirator 100.

In the illustrated embodiment of FIG. 1B, the respirator 100 further includes a nose foam 113 attached to a surface (the first major surface 102A in FIG. 1B) of the mask body 102. The nose foam 113 may improve a fit and/or comfort over the nose of the user 10 (shown in FIG. 1A).

In some embodiments, the nose foam 113 includes polypropylene in an amount of between 60 and 100 weight percent. In some embodiments, the nose foam 113 may include polypropylene in an amount of 65, 70, 75, 80, 85, 90, or 95 weight percent. In some embodiments, the nose foam 113 may be entirely made of polypropylene. In some embodiments, the nose foam 113 includes uncrosslinked polymer.

In the illustrated embodiment of FIGS. 1A and 1B, the respirator 100 further includes an exhalation valve 130 attached to the mask body 102 and disposed proximal to an outlet 103 of the mask body 102. Further, the exhalation valve 130 includes polypropylene in an amount of between 60 and 100 weight percent.

The mask body 102 may be provided with the outlet 103 that is located where the exhalation valve 130 is attached to the mask body 102 so that exhaled air can exit the exhalation valve 130 without having to pass through the mask body 102. The outlet 103 may fully extend between the first major surface 102A and the second major surface 102B of the mask body 102. The exhalation valve 130 may open in response to increased pressure inside the respirator 100. Such increased pressure may occur when the user 10 exhales. However, the exhalation valve 130 is optional and may be omitted from the respirator 100. In such cases, the mask body 102 may exclude the outlet 103, and the user 10 may exhale through the mask body 102.

FIG. 1C illustrates a schematic view of a face contact side of a respirator 200 according to another embodiment of the present disclosure. The respirator 200 is similar to the respirator 100 of FIGS. 1A and 1B, with like elements designated by like reference numerals. However, the respirator 200 includes a full perimeter seal 114 instead of the nose foam 113 of the respirator 100. Furthermore, the respirator 200 excludes the exhalation valve 130 of the respirator 100 of FIGS. 1A and 1B.

Specifically, in the illustrated embodiment of FIG. 1C, the mask body 102 includes the full perimeter seal 114 attached to a surface (the first major surface 102A in FIG. 1C) of the mask body 102. The full perimeter seal 114 may improve a fit and/or a seal of the respirator 100 when worn by the user 10 (shown in FIG. 1A).

In some embodiments, the full perimeter seal 114 includes polypropylene in an amount of between 60 and 100 weight percent. In some embodiments, the full perimeter seal 114 may include polypropylene in an amount of 65, 70, 75, 80, 85, 90, or 95 weight percent. In some embodiments, the full perimeter seal 114 may be entirely made of polypropylene. In some embodiments, the full perimeter seal 114 may include uncrosslinked polymer.

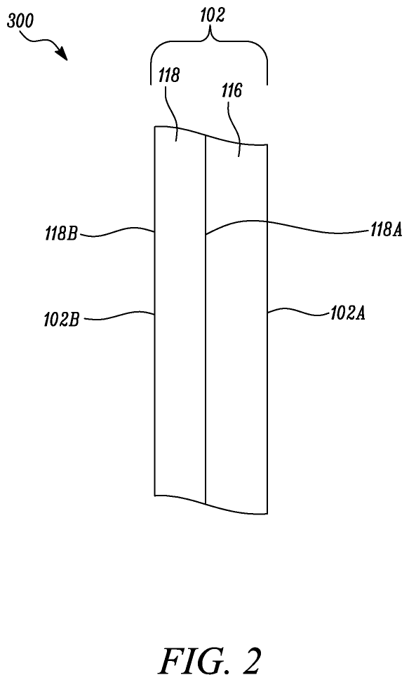

FIG. 2 illustrates a schematic cross-sectional view of a portion of a respirator 300 according to an embodiment of the present disclosure. The respirator 300 is similar to the respirator 100 of FIGS. 1A and 1B, with like elements designated by like reference numerals. Specifically, FIG. 2 illustrates a schematic cross-sectional view of the respirator 300 taken through the mask body 102 of the respirator 300.

In the illustrated embodiment of FIG. 2, the mask body 102 includes a filtering structure 116 and a support structure 118 supporting the filtering structure 116. The filtering structure 116 may be an air-permeable structure that is capable of removing contaminants from air that passes therethrough. For example, the filtering structure 116 may be an N95 filtering structure that may filter at least 95% of the contaminants from air.

In some embodiments, the filtering structure 116 may include polypropylene in an amount of between 60 and 100 weight percent. In some embodiments, the filtering structure 116 may be entirely made of polypropylene.

As discussed above, the filtering structure 116 is supported by the support structure 118. The support structure 118 may provide a shape to the mask body 102 and support to the filtering structure 116. In some embodiments, the support structure 118 is foldable. In such embodiments, the support structure 118 may allow the respirator 300 to be folded-flat during storage. Moreover, in such embodiments, the respirator 300 is a flat-fold respirator.

In some other embodiments, the support structure 118 is collapse resistant. In such embodiments, the support structure 118 may have, for example, a curved, hemispherical, cup-shape conforming to the face of the user 10 (shown in FIG. 1A). Consequently, the mask body 102 may have the curved, hemispherical, cup-shape.

Further, in some embodiments, the support structure 118 includes polypropylene-miscible copolymer in an amount of between 0 and 40 weight percent. In some embodiments, the support structure 118 may include polypropylene in an amount of between 60 and 100 weight percent.

The support structure 118 includes a first surface 118A and a second surface 118B opposite to the first surface 118A. In the illustrated embodiment of FIG. 2, the filtering structure 116 is disposed on the first surface 118A. Further, the filtering structure 116 defines the first major surface 102A of the mask body 102. Further, in the illustrated embodiment of FIG. 2, the second surface 118B defines the second major surface 102B of the mask body 102.

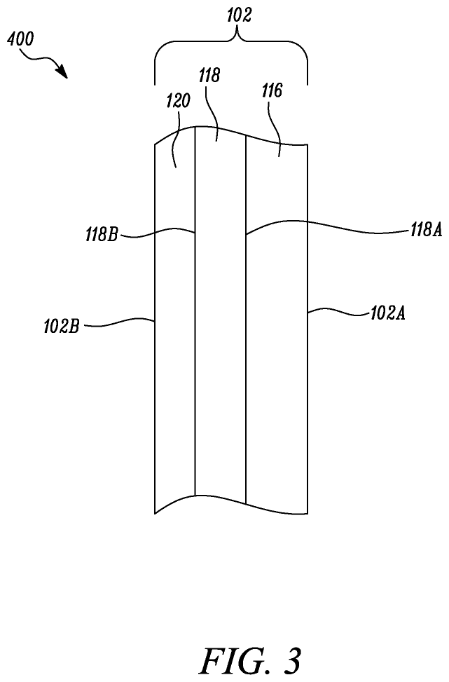

FIG. 3 illustrates a schematic cross-sectional view of a portion of a respirator 400 according to another embodiment of the present disclosure. The respirator 400 is similar to the respirator 300 of FIG. 2, with like elements designated by like reference numerals. However, the respirator 400 includes a different configuration of the mask body 102 as compared to the mask body 102 of the respirator 300 of FIG. 2.

In some embodiments, the mask body 102 further includes one or more cover webs 120 at least partially covering at least one of the filtering structure 116 and the support structure 118. For example, the mask body 102 may include one cover web 120 partially covering either the filtering structure 116 or the support structure 118. In another example, the mask body 102 may include two cover webs 120, such that one of the two cover webs 120 may partially cover the filtering structure 116 and the other of the two cover webs 120 may partially cover the support structure 118.

Specifically, in the illustrated embodiment of FIG. 3, the mask body 102 further includes the one or more cover webs 120 at least partially covering the filtering structure 116. More specifically, in the illustrated embodiment of FIG. 3, the one or more cover webs 120 are disposed on the second surface 118B of the support structure 118.

In the illustrated embodiment of FIG. 3, the one or more cover webs 120 define the second major surface 102B of the mask body 102 and the one or more cover webs 120 at least partially cover the support structure 118. The support structure 118 may support the one or more cover webs 120. Alternatively, in some other embodiments, the one or more cover webs 120 may be disposed on the filtering structure 116, may at least partially cover the filtering structure 116, and may define the first major surface 102A of the mask body 102.

In some embodiments, each of the one or more cover webs 120 includes polypropylene in an amount of between 60 and 100 weight percent. In some embodiments, each of the one or more cover webs 120 may include polypropylene in an amount of 65, 70, 75, 80, 85, 90, or 95 weight percent. In some embodiments, each of the one or more cover webs 120 may be entirely made of polypropylene.

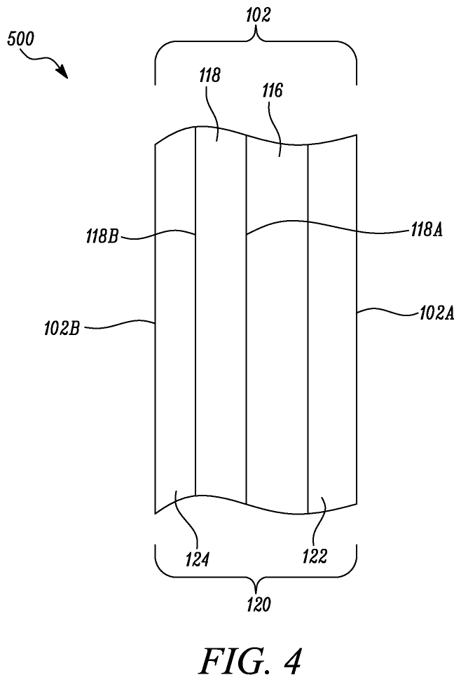

FIG. 4 illustrates a schematic cross-sectional view of a portion of a respirator 500 according to another embodiment of the present disclosure. The respirator 500 is similar to the respirator 400 of FIG. 3, with like elements designated by like reference numerals. However, the respirator 500 includes a different configuration of the mask body 102 as compared to the mask body 102 of the respirator 400 of FIG. 3.

Specifically, in the illustrated embodiment of FIG. 4, the filtering structure 116 is disposed on the first surface 118A of the support structure 118, and the one or more cover webs 120 include a first cover web 122 and a second cover web 124. In the illustrated embodiment of FIG. 4, the first cover web 122 is disposed on the filtering structure 116 opposite to the first surface 118A and defines the first major surface 102A of the mask body 102. Further, in the illustrated embodiment of FIG. 4, the second cover web 124 is disposed on the second surface 118B and defines the second major surface 102B of the mask body 102. Moreover, in the illustrated embodiment of FIG. 4, the first cover web 122 at least partially covers the filtering structure 116, and the second cover web 124 at least partially covers the support structure 118.

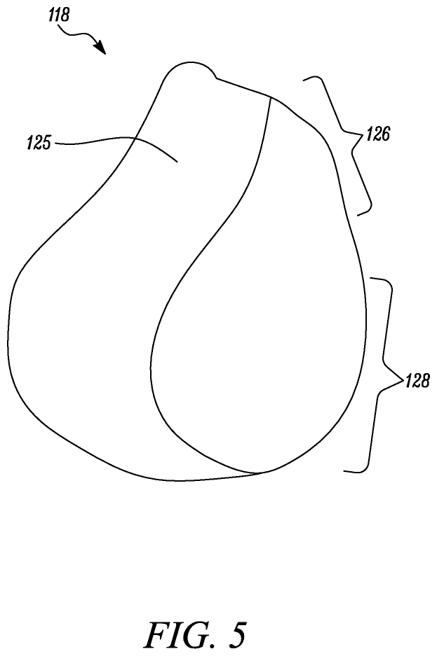

FIG. 5 shows a schematic perspective view of the support structure 118 according to an embodiment of the present disclosure.

As discussed above, in some embodiments, the support structure 118 is collapse resistant. In the illustrated embodiment of FIG. 5, the support structure 118 is a collapse resistant shell 125 including a protuberant nose portion 126. The protuberant nose portion 126 may accommodate the nose of the user 10 (shown in FIG. 1A). Further, in the illustrated embodiment of FIG. 5, the collapse resistant shell 125 includes a protuberant mouth portion 128. The protuberant mouth portion 128 may accommodate the mouth of the user 10.

The collapse resistant shell 125 may include any suitable size and shape (for example, a cup shape) that allows accommodation of the nose and mouth of the user 10. Advantageously, the collapse resistant shell 125 including the protuberant nose portion 126 may allow omission of the nose bar 106 (shown in FIG. 1A) from the respirator 100.

The collapse resistant shell 125 may be formed using a melt blowing process. In some cases, the collapse resistant shell 125 may tend to get embrittled. In some embodiments, the collapse resistant shell 125 further includes an elastomeric polymer including ethylene content in an amount of at least 3 weight percent. Ethylene content greater than 3 weight percent may prevent embrittlement of the collapse resistant shell 125. Specifically, in some embodiments, the collapse resistant shell 125 does not embrittle upon being subjected to a temperature ranging from 60 degrees Celsius to 80 degrees Celsius for 50 hours to 80 hours.

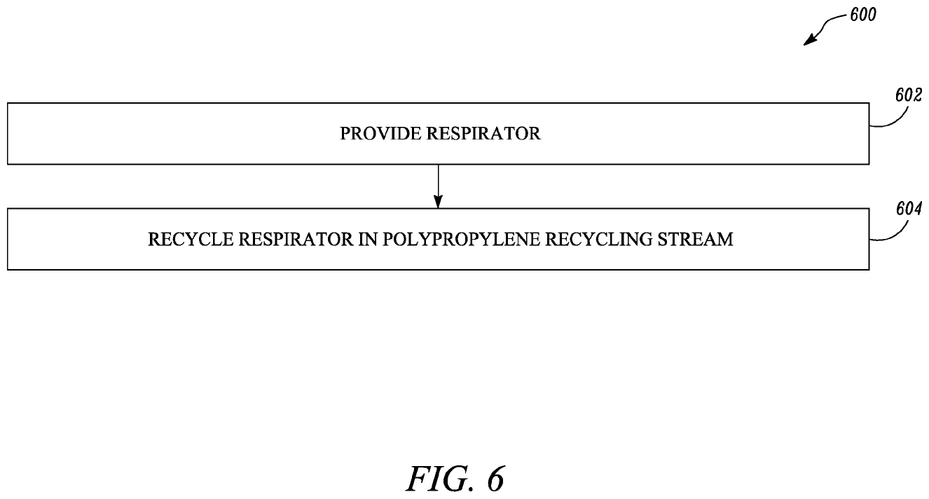

FIG. 6 shows a flowchart of a method 600 of recycling a respirator according to an embodiment of the present disclosure. In some embodiments, the method 600 may be used for recycling the respirator 100. In some embodiments, the method 600 may be used for recycling the respirator 200. In some embodiments, the method 600 may be used for recycling the respirator 300. In some embodiments, the method 600 may be used for recycling the respirator 400. In some embodiments, the method 600 may be used for recycling the respirator 500.

At step 602, the method 600 includes providing a respirator. The respirator includes a mask body including polypropylene in an amount of between 60 and 100 weight percent. The respirator further includes a harness attached to the mask body. The harness includes elastomeric polypropylene-miscible copolymer in an amount of between 80 and 100 weight percent. The respirator includes an overall composition of polypropylene of at least 80 weight percent. The respirator further includes an overall composition of ethylene of less than 10 weight percent.

For example, the method 600 may include providing the respirator 100. The method 600 may include providing the respirator 200. The method 600 may include providing the respirator 300. The method 600 may include providing the respirator 400. The method 600 may include providing the respirator 500.

At step 604, the method 600 further includes recycling the respirator in a polypropylene recycling stream. For example, the method 600 may include recycling the respirator 100, the respirator 200, the respirator 300, the respirator 400, or the respirator 500 in the polypropylene recycling stream.

In some embodiments, the respirator further includes a nose bar removably attached to a surface of the mask body. In some embodiments, the nose bar is made of a metal, a metal alloy, a plastic, or a non-metallic material.

In some embodiments, the method 600 further includes removing the nose bar from the respirator prior to recycling the respirator in the polypropylene recycling stream. For example, the method 600 may include removing the nose bar 106 from the respirator 100 prior to recycling the respirator 100 in the polypropylene recycling stream.

### ASPECTS

Aspect 1: A respirator comprising:

a mask body comprising polypropylene in an amount of between 60 and 100 weight percent; and

a harness attached to the mask body, the harness comprising elastomeric polypropylene-miscible copolymer in an amount of between 80 and 100 weight percent;

wherein the respirator comprises an overall composition of polypropylene of at least 80 weight percent, and wherein the respirator comprises an overall composition of ethylene of less than 10 weight percent.
Aspect 2: The respirator of aspect 1, wherein the mask body further comprises polypropylene-miscible copolymer in an amount of between 0 and 40 weight percent.
Aspect 3: The respirator of aspect 1 or 2, wherein the mask body comprises a filtering structure and a support structure supporting the filtering structure.
Aspect 4: The respirator of aspect 3, wherein the support structure comprises polypropylene-miscible copolymer in an amount of between 0 and 40 weight percent.
Aspect 5: The respirator of aspect 3 or 4, wherein the support structure is foldable, and wherein the respirator is a flat-fold respirator.
Aspect 6: The respirator of aspect 3 or 4, wherein the support structure is a collapse resistant shell comprising a protuberant nose portion.
Aspect 7: The respirator of aspect 6, wherein the collapse resistant shell further comprises an elastomeric polymer comprising ethylene content in an amount of at least 3 weight percent.
Aspect 8: The respirator of aspect 6 or 7, wherein the collapse resistant shell does not embrittle upon being subjected to a temperature ranging from 60 degrees Celsius to 80 degrees Celsius for 50 hours to 80 hours.
Aspect 9: The respirator of any one of aspects 3-8, wherein the support structure comprises a first surface and a second surface opposite to the first surface, wherein the filtering structure is disposed on the first surface and defines a first major surface of the mask body, and wherein the second surface defines a second major surface of the mask body.
Aspect 10: The respirator of any one of aspects 1-9, wherein each of the mask body and the harness is ultrasonically weldable, and wherein the harness is attached to the mask body via ultrasonic welding.
Aspect 11: The respirator of any one of aspects 1-10, wherein the harness comprises a head suspension system.
Aspect 12: The respirator of any one of aspects 1-11, wherein the harness further comprises ethylene in an amount of at least 10 weight percent.
Aspect 13: The respirator of any one of aspects 1-12, wherein the harness further comprises a slip agent in an amount of less than 7 weight percent.
Aspect 14: The respirator of aspect 13, wherein the slip agent comprises a fatty acid amide.
Aspect 15: The respirator of aspect 13, wherein the slip agent comprises at least one of erucamide, ethylene bis stearamide, silica gel, behenamide, and stearamide.
Aspect 16: The respirator of any one of aspects 1-15, wherein the harness comprises primary fatty acid in an amount of 2.5 weight percent and silica gel in an amount of 2.5 weight percent.
Aspect 17: The respirator of any one of aspects 3-16, wherein the mask body further comprises one or more cover webs at least partially covering at least one of the filtering structure and the support structure, each of the one or more cover webs comprising polypropylene in an amount of between 60 and 100 weight percent.
Aspect 18: The respirator of aspect 17, wherein the support structure comprises a first surface and a second surface opposite to the first surface, wherein the filtering structure is disposed on the first surface, wherein the one or more cover webs comprise a first cover web and an second cover web, wherein the first cover web is disposed on the filtering structure opposite to the first surface and defines a first major surface of the mask body, and wherein the second cover web is disposed on the second surface and defines a second major surface of the mask body.
Aspect 19: The respirator of any one of aspects 1-18, further comprising a nose bar removably attached to a surface of the mask body.
Aspect 20: The respirator of aspect 19, wherein the nose bar is made of a metal or a metal alloy.
Aspect 21: The respirator of aspect 19, wherein the nose bar is made of a non-metallic material.
Aspect 22: The respirator of any one of aspects 1-21, further comprising a nose foam attached to a surface of the mask body and comprising polypropylene in an amount of between 60 and 100 weight percent.
Aspect 23: The respirator of any one of aspects 1-21, further comprising a full perimeter seal attached to a surface of the mask body and comprising polypropylene in an amount of between 60 and 100 weight percent.
Aspect 24: The respirator of aspect 22, wherein the nose foam comprises uncrosslinked polymer.
Aspect 25: The respirator of any one of aspects 1-24, further comprising printed indicia disposed on a surface of the mask body.
Aspect 26: The respirator of aspect 25, wherein the printed indicia comprise an ASTM resin classification code.
Aspect 27: The respirator of aspect 25 or 26, wherein the printed indicia comprise one or more labels describing a material of the respirator to facilitate recycling thereof.
Aspect 28: The respirator of any one of aspects 25-27, wherein the printed indicia comprise one or more labels describing recycling instructions.
Aspect 29: The respirator of any one of aspects 1-28, further comprising an exhalation valve attached to the mask body and disposed proximal to an outlet of the mask body, wherein the exhalation valve comprises polypropylene in an amount of between 60 and 100 weight percent.
Aspect 30: A method of recycling the respirator of any one of aspects 1-29, further comprising recycling the respirator in a polypropylene recycling stream.
Aspect 31: A method of recycling a respirator, the method comprising:

providing a respirator, the respirator comprising:

a mask body comprising polypropylene in an amount of between 60 and 100 weight percent; and

a harness attached to the mask body, the harness comprising elastomeric polypropylene-miscible copolymer in an amount of between 80 and 100 weight percent;

wherein the respirator comprises an overall composition of polypropylene of at least 80 weight percent, and wherein the respirator comprises an overall composition of ethylene of less than 10 weight percent; and

recycling the respirator in a polypropylene recycling stream.
Aspect 32: The method of aspect 31, wherein the respirator further comprises a nose bar removably attached to a surface of the mask body, and wherein the method further comprises removing the nose bar from the respirator prior to recycling the respirator in the polypropylene recycling stream.
Aspect 33: The method of aspect 32, wherein the nose bar is made of a metal, a metal alloy, a plastic, or a non-metallic material.
Aspect 34: A respirator comprising an overall composition of polypropylene of at least 80 weight percent and an overall composition of ethylene of less than 10 weight percent, such that the respirator is consistent with definition of recyclable according to association of plastic recyclers (APR) standards for polypropylene.
Aspect 35: The respirator of aspect 34, wherein the respirator comprises:

a mask body comprising polypropylene in an amount of between 60 and 100 weight percent; and

a harness attached to the mask body, the harness comprising elastomeric polypropylene-miscible copolymer in an amount of between 80 and 100 weight percent.
Aspect 36: The respirator of aspect 35, wherein the mask body further comprises polypropylene-miscible copolymer in an amount of between 0 and 40 weight percent.
Aspect 37: The respirator of aspect 35 or 36, wherein the mask body comprises a filtering structure and a support structure supporting the filtering structure.
Aspect 38: The respirator of aspect 37, wherein the support structure comprises polypropylene-miscible copolymer in an amount of between 0 and 40 weight percent.
Aspect 39: The respirator of aspect 37 or 38, wherein the support structure is a collapse resistant shell comprising a protuberant nose portion, and wherein the collapse resistant shell comprises an elastomeric polymer comprising ethylene content of at least 3 weight percent.
Aspect 40: The respirator of aspect 35-39, wherein the harness further comprises a slip agent of less than 7 weight percent.
Aspect 41: The respirator of aspect 40, wherein the slip agent comprises a fatty acid amide.
Aspect 42: The respirator of aspect 40, wherein the slip agent comprises at least one of erucamide, ethylene bis stearamide, silica gel, behenamide, and stearamide.
Aspect 43: The respirator of any one of aspects 35-42, wherein the harness comprises primary fatty acid of 2.5 weight percent, and silica gel of 2.5 weight percent.
Aspect 44: The respirator of any one of aspects 37-43, wherein the mask body further comprises one or more cover webs at least partially covering at least one of the filtering structure and the support structure, each of the one or more cover webs comprising polypropylene in an amount of between 60 and 100 weight percent.
Aspect 45: The respirator of any one of aspects 35-44, further comprising a nose foam attached to a surface of the mask body and comprising polypropylene in an amount of between 60 and 100 weight percent.
Aspect 46: The respirator of any one of aspects 35-44, further comprising a full perimeter seal attached to a surface of the mask body and comprising polypropylene in an amount of between 60 and 100 weight percent.
Aspect 47: The respirator of aspect 45, wherein the nose foam comprises uncrosslinked polymer.
Aspect 48: The respirator of any one of aspects 35-47, further comprising an exhalation valve attached to the mask body and disposed proximal to an outlet of the mask body, wherein the exhalation valve comprises polypropylene in an amount of between 60 and 100 weight percent.

### EXAMPLES

Some of the materials used in the following examples are commercially available under the designation VISTAMAXX™ from ExxonMobil Chemical Co. of Houston.

### Comparative Examples 1-2 (CE1, CE2) and Examples 1-2 (E1, E2)

Several sample harnesses were prepared from materials containing polyolefin elastomers. The sample harnesses were tested to be used as a replacement for a conventional harness that was prepared using isoprene.

The materials used for the sample harnesses are provided in Table 1, below. Table 1 further includes the density and the ethylene percentage of each of the materials used for preparing the sample harnesses. The ethylene percentage was estimated from the material density.

TABLE 1

| Material (Commercial Name) | Density | Ethylene Percentage |
|---|---|---|
| Vistamaxx 1120 | 0.861 | 15.5 |
| Vistamaxx 2120 | 0.868 | 12.6 |
| Vistamaxx 8880 | 0.879 | 6.0 |

Several films with a nominal thickness of 15 mil (0.38 millimeters) were prepared from each of the materials listed in Table 1. Sample films were cut into 4 inch strips and tested for elongation at break (in %), tensile load at 50% elongation (in pound-force or lbf), tensile load at 150% elongation (in pound-force or lbf), and maximum load (in pound-force or lbf). The testing was performed on an Instron tensile test system where each sample was placed without slack in grips that were initially 4 inches apart, then drawn at a rate of 20 in/min, while the drawing force and linear displacement were measured.

The elongation at break (in %), the tensile load at 50% elongation (in lbf), the tensile load at 150% elongation (in lbf), and the maximum load (in lbf) corresponding to the materials (mentioned in Table 1 and isoprene) are provided in Table 2 below. Isoprene that was used for testing was from 3M Particulate Respirator 8210.

TABLE 2

| | | | Tensile load | Tensile load | |
|---|---|---|---|---|---|
| | | Elongation | at 50% | at 150% | |
| | | at | elongation | elongation | Maximum |
| Sample Film | | Break (%) | (lbf) | (lbf) | load (lbf) |
| Vistamaxx | E-1 | 872 | 1.01 | 1.16 | 3.91 |
| 1120 | | | | | |
| Vistamaxx | E-2 | 828 | 1.52 | 1.56 | 3.88 |
| 2120 | | | | | |
| Vistamaxx | C-1 | 9.2 | 1.78 | 1.81 | 4.7 |
| 8880 | | | | | |
| Isoprene | C-2 | 614 | 1.18 | 1.70 | 5.0 |

It was concluded that the materials including ethylene percentage greater than 11% were suitable for forming harnesses. Therefore, the materials including ethylene percentage greater than 11% were considered for making the harnesses as a suitable replacement for isoprene.

### Comparative Examples 3-10 (CE3-CE10) and Examples 3-23 (E3-E23)

The elastomeric harnesses made from Vistamaxx materials (mentioned in Table 1) demonstrated a level of self-adhesion and stickiness that made them unsuitable for use as a harness material.

To decrease the self-adhesion and stickiness, slip agents were added to the elastomeric harnesses. A film made from Vistamaxx 1120 with 700 ppm of a slip agent was prepared. The film showed reduced self-adhesion to a level suitable for use as a harness. For comparison, an identically dimensioned film made from Vistamaxx 1120 without the slip agent was prepared.

Both the films were folded in half and passed through a 2 inch rubber Marshalltown roller. Conclusively, the film without the slip agent stuck to itself, while the film including the slip agent did not stick to itself and regained its original shape.

Some examples of the slip agent are provided in Table 3 below. Table 3 further includes supplier name and shorthand name corresponding to the slip agent.

TABLE 3

| Slip Agent | Supplier | Shorthand Name |
|---|---|---|
| Calcium Stearate | Sigma-Aldrich | CaSt |
| Erucamide | Alfa Aesar | Erucamide |
| Ethylene-bis-Stearamide | Alfa Aesar | EBS |
| Silica Gel | Sigma-Aldrich | SG-1 |
| Crodamide SL-BE | Croda | Croda-SL |
| Crodamide BR-BE | Croda | Croda-BL |

A set of sample films was prepared from Vistamaxx 1120 listed in Table 1 and the slip agents listed in Table 3. The nominal thickness of each of the sample films was 15 mil. The sample films were evaluated for self-adhesion. Further, the sample films were grouped based on their ability to resist the self-adhesion. Specifically, in terms of performance, the sample films were grouped in 6 groups and ranked from 1 to 6, with 6 being the worst, and 1 being the best.

The sample films ranked based on their ability to resist the self-adhesion are provided in Table 4 below. Table 4 further includes weight percentage of the slip agent corresponding to the sample films.

TABLE 4

| | Weight % of | | | | | |
|---|---|---|---|---|---|---|
| | Vistamaxx | Weight % of Slip Agent | | | | |
| | 1120 | CaSt | Erucamide | EBS | SG-1 | Ranking |
| C-3 | 100.0 | 0 | 0 | 0 | 0 | 6 |
| C-4 | 99.5 | 0.5 | 0 | 0 | 0 | 6 |
| C-5 | 98.9 | 1.1 | 0 | 0 | 0 | 6 |
| C-6 | 97.9 | 2.1 | 0 | 0 | 0 | 5 |
| C-7 | 99.5 | 0 | 0 | 0 | 0.5 | 5 |
| C-8 | 98.9 | 0 | 0 | 0 | 1.1 | 5 |
| C-9 | 97.9 | 0 | 0 | 0 | 2.1 | 5 |
| E-3 | 99.5 | 0 | 0.5 | 0 | 0 | 4 |
| E-4 | 98.9 | 0 | 1.1 | 0 | 0 | 4 |
| E-5 | 97.9 | 0 | 2.1 | 0 | 0 | 4 |
| E-6 | 96.4 | 0 | 3.6 | 0 | 0 | 4 |
| E-7 | 99.5 | 0 | 0 | 0.5 | 0 | 4 |
| E-8 | 98.9 | 0 | 0 | 1.1 | 0 | 4 |
| E-9 | 97.9 | 0 | 0 | 2.1 | 0 | 3 |
| E-10 | 98.0 | 0 | 1.0 | 0 | 1.0 | 2 |
| E-11 | 95.0 | 0 | 2.5 | 0 | 2.5 | 1 |

As depicted by Table 4, the sample film of Example 11 (E11) with Erucamide and SG-1 showed the best improvement in surface finish and slip properties among all the sample films.

Another set of sample films were prepared from Vistamaxx 1120 listed in Table 1 and the slip agents listed in Table 3. The nominal thickness of each of the sample films was 15 mil. The sample films were evaluated for self-adhesion. Further, the sample films were grouped based on their ability to resist the self-adhesion. Specifically, in terms of performance, the sample films were grouped as “easy release”, “good release”, average release ”, “somewhat tight”, and “tight”, with tight being the worst, and easy release being the best. The sample films were ranked from 1 to 17, with 17 being the worst, and 1 being the best.

The sample films were grouped and ranked based on their ability to resist self-adhesion and are provided in Table 5 below. Table 5 further includes weight percentage of the slip agents corresponding to the sample films.

TABLE 5

| | Weight % | | | | | |
|---|---|---|---|---|---|---|
| | Vistamaxx | Weight % of Slip Agent | | | | |
| | 1120 | Croda SL | Croda BR | SG-1 | Grouping | Ranking |
| C-10 | 100.00 | 0 | 0 | 0 | Tight | 13 |
| E-12 | 99.93 | 0.07 | 0 | 0 | Somewhat Tight | 10 |
| E-13 | 99.86 | 0.14 | 0 | 0 | Average Release | 2 |
| E-14 | 99.75 | 0.25 | 0 | 0 | Average Release | 3 |
| E-15 | 99.50 | 0.50 | 0 | 0 | Easy Release | 1 |
| E-16 | 99.93 | 0 | 0.07 | 0 | Average Release | 4 |
| E-17 | 99.86 | 0 | 0.14 | 0 | Average Release | 5 |
| E-18 | 99.50 | 0 | 0.50 | 0 | Somewhat Tight | 11 |
| E-19 | 99.00 | 0 | 1.00 | 0 | Good Release | 6 |
| E-20 | 99.86 | 0.07 | 0 | 0.07 | Somewhat Tight | 12 |
| E-21 | 98.00 | 1.00 | 0 | 1.00 | Good Release | 7 |
| E-22 | 99.86 | 0 | 0.07 | 0.07 | Good Release | 8 |
| E-23 | 98.00 | 0 | 1.00 | 1.00 | Good Release | 9 |

As shown in Table 5, many workhorse additives were able to achieve good performance.

### Example 24

Sample nose foams were prepared from materials provided in Table 6 below.

TABLE 6

| Material | Supplier | Description |
|---|---|---|
| PP-Foam 1 | Pregis | Low density PP foam |
| Volara Foam (0.059) | 4TBX | Crosslinked EVA |

The sample nose foams were tested to be used as a replacement for a conventional polyurethane nose foam.

The critical aspects for recycling are both the material and its ability to be remelted. Foams are often crosslinked, so a requirement of the sample nose foams was that the foam must be re-meltable. Therefore, the sample nose foams were tested for their ability to be remelted.

A swatch of the sample nose foam was cut and placed in an aluminum pan. The pan was placed on a hotplate that was heated to 195 degrees Celsius. After 5 minutes of heating, an observation was noted regarding its physical state, that is, the PP nose foam was able to be remelted, whereas the crosslinked EVA nose foam was not able to be remelted.

### Comparative Examples 11-20 and Examples 25-32

Several sample shells were prepared using different compositions of materials provided in Table 7 shown below.

TABLE 7

| Material | Supplier | Resin | Notes |
|---|---|---|---|
| PP-3860 | Total | Polypropylene | 100 melt flow index |
| | | | (mfi) |
| PP-3766 | Total | Polypropylene | 24 mfi |
| Vistamaxx 1120 | Exxon | PP-co-PE | 15% Ethylene |
| Vistamaxx 8880 | Exxon | PP-co-PE | 6% Ethylene |
| Eastoflex P1023 | Eastman | atactic PP | Web Adhesive |

A first set of sample shells was aged for 4 days at 70 degrees Celsius and tested for snapping. During the snap test, the sample shells were flexed in multiple dimensions to see if they crack. Formulation of resins corresponding to the first set of sample shells are provided in Table 8 below. Table 8 further includes results of the snap test.

TABLE 8

| | | | Eastoflex | Vistamaxx | |
|---|---|---|---|---|---|
| | PP-3766 | PP-3860 | P1023 | 1120 | Snap Test |
| C-11 | 0 | 80 | 20 | 0 | Crack |
| E-25 | 0 | 80 | 0 | 20 | No Crack |
| C-12 | 10 | 90 | 0 | 0 | Crack |
| E-26 | 40 | 40 | 20 | 0 | No Crack |
| E-27 | 40 | 40 | 0 | 20 | No Crack |
| C-13 | 50 | 50 | 0 | 0 | Crack |
| C-14 | 80 | 0 | 20 | 0 | Little Crack |
| C-15 | 80 | 0 | 0 | 20 | No Crack |
| C-16 | 90 | 0 | 10 | 0 | Little Crack |
| C-17 | 90 | 0 | 0 | 10 | Little Crack |
| E-28 | 60 | 0 | 0 | 40 | No Crack |

A second set of sample shells were tested under a more rigorous testing protocol where the sample shells were aged and tested at 70 degrees Celsius for 1 week, 2 weeks, and 4 weeks. The testing protocol included the following tests:
1) Corner cracking,
2) Hand crumple, and
3) A maul test where a 7 lbs maul was pounded into the shell.

A composite 1-5 ranking system that combined the observations into a numerical score was used, with 1 being the lowest, and 5 being the highest. For corner cracking, all four corners were individually cracked. A simple Y/N value was reported for the crumple and maul test, where a Y indicated that the specified test resulted in a crack.

Formulation of resins corresponding to the second set of sample shells is provided in Table 9 below. Table 9 further includes results of the various test mentioned above. Table 9 further includes ethylene percentage of the sample shells.

TABLE 9

| | | PP | PP | VM | VM | % | Corner | | | Overall |
|---|---|---|---|---|---|---|---|---|---|---|
| | | 3766 | 3860 | 1120 | 8880 | Ethylene | Cracking | Crumple | Maul | Ranking |
| C-18 | Formulation | 50 | 50 | 0 | 0 | 0.0 | 0 | 0 | 0 | 0 |
| | Week 1 | 0 | 0 | 0 | 0 | 0 | 0/4 | N | Y | 3 |
| | Week 2 | 0 | 0 | 0 | 0 | 0 | 0/4 | N | Y | 3 |
| | Week 4 | 0 | 0 | 0 | 0 | 0 | 0/4 | N | Y | 3 |
| C-19 | Formulation | 40 | 40 | 0 | 20 | 1.2 | 0 | 0 | 0 | 0 |
| | Week 1 | 0 | 0 | 0 | 0 | 0 | 1/4 | N | Y | 2 |
| | Week 2 | 0 | 0 | 0 | 0 | 0 | 1/4 | N | Y | 2 |
| | Week 4 | 0 | 0 | 0 | 0 | 0 | 0/4 | N | ~Y | 4.5 |
| C-20 | Formulation | 35 | 35 | 0 | 30 | 1.8 | 0 | 0 | 0 | 0 |
| | Week 1 | 0 | 0 | 0 | 0 | 0 | 1/4 | N | Y | 4 |
| | Week 2 | 0 | 0 | 0 | 0 | 0 | 2/4 | N | ~Y | 4 |
| | Week 4 | 0 | 0 | 0 | 0 | 0 | 0/4 | N | N | 5 |
| E-29 | Formulation | 25 | 25 | 0 | 50 | 3.0 | 0 | 0 | 0 | 0 |
| | Week 1 | 0 | 0 | 0 | 0 | 0 | 0/4 | N | N | 5 |
| | Week 2 | 0 | 0 | 0 | 0 | 0 | 0/4 | N | N | 5 |
| | Week 4 | 0 | 0 | 0 | 0 | 0 | 0/4 | N | N | 5 |
| E-30 | Formulation | 40 | 40 | 20 | 0 | 3.2 | 0 | 0 | 0 | 0 |
| | Week 1 | 0 | 0 | 0 | 0 | 0 | 0/4 | N | N | 5 |
| | Week 2 | 0 | 0 | 0 | 0 | 0 | 0/4 | N | N | 5 |
| | Week 4 | 0 | 0 | 0 | 0 | 0 | 0/4 | N | N | 5 |
| E-31 | Formulation | 35 | 35 | 30 | 0 | 4.8 | 0 | 0 | 0 | 0 |
| | Week 1 | 0 | 0 | 0 | 0 | 0 | 0/4 | N | N | 5 |
| | Week 2 | 0 | 0 | 0 | 0 | 0 | 0/4 | N | N | 5 |
| | Week 4 | 0 | 0 | 0 | 0 | 0 | 0/4 | N | N | 5 |
| E-32 | Formulation | 25 | 25 | 50 | 0 | 8.0 | 0 | 0 | 0 | 0 |
| | Week 1 | 0 | 0 | 0 | 0 | 0 | 0/4 | N | N | 5 |
| | Week 2 | 0 | 0 | 0 | 0 | 0 | 0/4 | N | N | 5 |
| | Week 4 | 0 | 0 | 0 | 0 | 0 | 0/4 | N | N | 5 |

It was concluded that the sample shells including ethylene percentage greater than 3% showed good resistance against embrittlement.

### Example 33

Two respirators were selected and tested using the metal detection protocols. The equipment used for the test was a Eriez Metal Xtreme Test Line. For the test, each of the respirators was tested in two directions: a plow direction, and an arrow direction perpendicular to the plow direction. Each of the respirators was passed through a metal detector. The amount of metal that is permissible was characterized through its effective sphere size. A response registered by the metal detector was converted to an equivalent sphere size, which is to say that a sphere of that size will trigger a response equal to that of the respirator.

Results of the test are provided in Table 10 below.

TABLE 10

| Respirator | Arrow | Plow | Determination |
|---|---|---|---|
| Cup style | 7.0 | 7.5 | Permissible but not preferred |
| Foldable | 7.0 | 10.5 | Permissible but not preferred |

As depicted by Table 10, a metal content of each of the two respirators was under a permissible range. However, the components of the two respirators containing metallic content, i.e., nose bars, were not preferred according to APR protocols.

### Example 34

A sample respirator was designed under recycling standards. A proposed construction of the sample respirator, i.e., materials corresponding to different components of the sample respirator, are provided in Table 11 below. Table 11 further includes a lowest weight (in grams) and a highest weight (in grams) for each component of the sample respirator. Table 11 further includes a target weight of each component of the sample respirator. A PP-co-PE elastomer with 16% ethylene content was modeled for the proposed construction.

TABLE 11

| | | Target | Lowest | Highest |
|---|---|---|---|---|
| | | Weight | Weight | Weight |
| Component | Material | (grams) | (grams) | (grams) |
| Shell | 20% PP-co-PE | 5.50 | 4.50 | 6.50 |
| Harness | 100% PP-co-PE | 1.50 | 1.25 | 1.75 |
| Filter | 100% PP | 1.00 | 1.00 | 1.00 |
| Cover Web | 100% PP | 0.50 | 0.50 | 0.50 |
| Foam | 100% PP | 0.10 | 0.10 | 0.10 |
| Total Weight | | 8.60 | 7.35 | 9.85 |
| (grams) | | | | |
| Total % | | 4.8 | 4.7 | 5.0 |
| Ethylene | | | | |

According to the recycling standards, a respirator recyclable in a polypropylene recycling stream includes an overall composition of ethylene less than 10 weight percent.

As depicted by Table 11, the total ethylene percentage of the sample respirator was 4.8% and the total weight of the ethylene in the sample respirator was 0.18 grams. Therefore, the sample respirator was recyclable in a polypropylene recycling stream according to the recycling standards.

It is to be recognized that depending on the example, certain acts or events of any of the methods described herein can be performed in a different sequence, may be added, merged, or left out altogether (e.g., not all described acts or events are necessary for the practice of the method).

Various examples have been described. These and other examples are within the scope of the following claims.

1. A respirator comprising:
a mask body comprising polypropylene in an amount of between 60 and 100 weight percent, wherein the mask body comprises a polypropylene filtering structure and a support structure supporting the filtering structure, wherein the support structure is a collapse resistant shell that comprises (i) polypropylene-miscible copolymer in an amount of between 0 and 40 weight percent; and (ii) an elastomeric polymer comprising ethylene content in an amount of at least 3 weight percent; and
a harness attached to the mask body, the harness comprising elastomeric polypropylene-miscible copolymer in an amount of between 80 and 100 weight percent;
wherein the respirator comprises an overall composition of polypropylene of at least 80 weight percent, and wherein the respirator comprises an overall composition of ethylene of less than 10 weight percent.

2-4. (cancelled)

5. The respirator of claim 1, wherein the support structure is foldable, and wherein the respirator is a flat-fold respirator.

6. The respirator of claim 1, wherein the support structure comprises a protuberant nose portion.

7. (canceled)

8. The respirator of claim 1, wherein the collapse resistant shell does not embrittle upon being subjected to a temperature ranging from 60 degrees Celsius to 80 degrees Celsius for 50 hours to 80 hours.

9. The respirator of claim 1, wherein the support structure comprises a first surface and a second surface opposite to the first surface, wherein the filtering structure is disposed on the first surface and defines a first major surface of the mask body, and wherein the second surface defines a second major surface of the mask body.

10. The respirator of claim 1, wherein each of the mask body and the harness is ultrasonically weldable, and wherein the harness is attached to the mask body via ultrasonic welding.

11. The respirator of claim 1, wherein the harness comprises a head suspension system.

12. The respirator of claim 1, wherein the harness further comprises ethylene in an amount of at least 10 weight percent.

13. The respirator of claim 1, wherein the harness further comprises a slip agent in an amount of less than 7 weight percent.

14. The respirator of claim 13, wherein the slip agent comprises a fatty acid amide.

15. The respirator of claim 13, wherein the slip agent comprises at least one of erucamide, ethylene bis stearamide, silica gel, behenamide, and stearamide.

16. The respirator of claim 1, wherein the harness comprises primary fatty acid in an amount of 2.5 weight percent and silica gel in an amount of 2.5 weight percent.

17. The respirator of claim 1, wherein the mask body further comprises one or more cover webs at least partially covering at least one of the filtering structure and the support structure, each of the one or more cover webs comprising polypropylene in an amount of between 60 and 100 weight percent.

18. The respirator of claim 17, wherein the support structure comprises a first surface and a second surface opposite to the first surface, wherein the filtering structure is disposed on the first surface, wherein the one or more cover webs comprise a first cover web and an second cover web, wherein the first cover web is disposed on the filtering structure opposite to the first surface and defines a first major surface of the mask body, and wherein the second cover web is disposed on the second surface and defines a second major surface of the mask body.

19. The respirator of claim 1, further comprising a nose bar removably attached to a surface of the mask body.

20. The respirator of claim 1, further comprising a nose foam attached to a surface of the mask body and comprising polypropylene in an amount of between 60 and 100 weight percent.

21. The respirator of claim 1, further comprising a full perimeter seal attached to a surface of the mask body and comprising polypropylene in an amount of between 60 and 100 weight percent.

22. The respirator of claim 20, wherein the nose foam comprises uncrosslinked polymer.

23. The respirator of claim 1, further comprising an exhalation valve attached to the mask body and disposed proximal to an outlet of the mask body, wherein the exhalation valve comprises polypropylene in an amount of between 60 and 100 weight percent.

24. A method of recycling the respirator according to claim 1, further comprising recycling the respirator in a polypropylene recycling stream.
